(19) United States
(12) Patent Application Publication
(10) Pub. No.: US 2022/0357516 A1
(43) Pub. Date: Nov. 10, 2022

(54) MULTIFIBER CONNECTOR FOR CONCENTRIC MUTLI-CORE FIBER

(71) Applicant: COMMSCOPE TECHNOLOGIES LLC, Hickory, NC (US)

(72) Inventor: Michael Aaron KADAR-KALLEN, Harrisburg, PA (US)

(73) Assignee: COMMSCOPE TECHNOLOGIES LLC, Hickory, NC (US)

(21) Appl. No.: 17/621,324

(22) PCT Filed: Jun. 19, 2020
(86) PCT No.: PCT/US2020/038750

§ 371 Date: Dec. 21, 2021

Related U.S. Application Data
(60) Provisional application No. 62/864,774, filed on Jun. 21, 2019.

(51) Int. Cl. G02B 6/293; G02B 6/02

(52) U.S. Cl. CPC G02B 6/29382; G02B 6/29305; G02B 6/02042

(57) ABSTRACT

The invention is related to devices that couple light into and out of concentric multicore fibers (MCFs). One embodiment of the invention is directed to a multiplexing/demultiplexing coupler, formed using at least two diffractive optical elements, so that light from one of the cores of the concentric MCF exits the coupler along a first axis and the light from another of the cores of the MCF exits coupler along another axis displaced form the first axis. In another embodiment, an add/drop filter includes at least one diffractive optical element, and directs light from one core of the concentric MCF to one fiber and light from one or more other cores of the concentric MCF to another fiber. In another embodiment, a mixing coupler transmits light from inner and outer cores of a first concentric MCF respectively to outer and inner cores of a second concentric MCF.

### CROSS-REFERENCE TO RELATED APPLICATION

This application is being filed on Jun. 19, 2020 as a PCT International Patent Application and claims the benefit of U.S. Patent Application Ser. No. 62/864,774, filed on Jun. 21, 2019, the disclosure of which is incorporated herein by reference in its entirety.

### BACKGROUND OF THE INVENTION

The present invention is generally directed to optical communications, and more specifically to improved methods for increasing the information transmission capacity for a single optical fiber.

Historically, several steps have been taken to improve the information transmission bandwidth in single mode fiber (SMF) optical communications systems, which are typically used for transmitting information over distances of a kilometer or more. Low transmission loss silica fibers were developed in the late 1970s and early 1980s, permitting the use of silica fibers over greater distances. The advent of erbium-doped fiber amplifiers (EDFAs), providing amplification for signals around 1550 nm, permitted the transmission of signals over even greater distances, while the introduction of wavelength division multiplexing/demultiplexing (WDM) extended the bandwidth of silica fibers by permitting a single mode silica fiber to carry different optical signals at different wavelengths. Optical communication systems have further benefitted from the introduction of advanced techniques such as polarization multiplexing and higher order modulation schemes to increase spectral efficiency (bits/s/Hz). However, current SMF optical transmission systems are now approaching their intrinsic capacity limits, and it is expected that they will be unable to meet future capacity requirements.

One approach being considered for increasing fiber capacity is space division multiplexing (SDM), in which different optical signals are physically (spatially) separated from each other within the same fiber. One particular implementation of SDM is to use a multi-core fiber (MCF), in which a number of different single-mode cores are contained within the same cladding material, laterally separated from each other within the cladding. An important issue for MCF is that crosstalk between cores or modes increases with transmission distance, and/or arises due to bends and fiber imperfections. Extensive digital signal processing is, therefore, needed to perform channel characterization and cope with the crosstalk in a fashion similar to multiple-input multiple-output (MIMO) transmission in radio systems. Furthermore, it is difficult and expensive to manufacture optical fibers having multiple cores within a single cladding. Furthermore, connectivity of the MCF is complicated because the multiple cores require precise rotational alignment of the fiber end about the fiber axis in order for the cores to be aligned to another MCF fiber.

Another proposed implementation of SDM relies on a fiber having a single core with a diameter that is larger than required for single-mode operation and which supports the propagation of a small number of modes. This fiber is referred to as a few-mode fiber (FMF). In a perfectly straight and circularly symmetric fiber, the modal electromagnetic fields do not interact in the sense that the power carried by each mode remains unchanged as the total electromagnetic field propagates in the fiber, thus theoretically each mode can act as an independent transmission channel. However, due to fiber imperfections and/or bends, a mode couples power to other modes, predominantly to those that have similar propagation coefficients. Over long distances, the optical power is likely to be distributed over multiple modes. This can be problematic, however, because a mode couples to a specific linear combination of all FMF modes, and the excitation of another mode couples to a linear combination of all FMF modes that is still orthogonal. With the aid of digital signal processing, the original signals can thus still be recovered. The refractive index profile of a typical FMF has a parabolic shape in the core region, to mitigate differential mode delay, i.e., to assure that the arrival times of all the modes are very similar. This relaxes the requirements on the size of the digital signal processor (DSP) required for signal analysis at the receiver.

Another proposed implementation of SDM relies on optical angular momentum (OAM) multiplexing in a fiber. Difficulties with this approach include the implementation of mode (de)multiplexers having high mode selectivity and avoiding the 1/N insertion loss associated with cascaded beam splitters.

Accordingly, there is a need for improved methods of implementing SDM that can reduce the effects of the problems discussed above. One approach to SDM is to use a fiber with multiple concentric cores. One issue for developing an optical fiber system based around concentric multicore fibers (“concentric MCFs”) is to develop methods of coupling light into and out of such fibers. It would be advantageous to develop efficient methods for coupling light into and out of concentric MCFs, either from/to conventional single core fibers, such as single mode fibers or other concentric MCFs. These coupling methods preferably maintain the advantage of concentric MCFs that, unlike conventional multicore fibers, there is no need to control the axial rotational alignment when connecting fibers. The concentric MCF fiber can, therefore, be implemented in systems using industry-standard connectors, such as SC, LC, MPO and other types of connectors.

This patent application addresses connectivity solutions for implementing a concentric MCF in an optical fiber system.

### SUMMARY OF THE INVENTION

One embodiment of the invention is directed to an optical device that has a first optical fiber comprising a first central core and at least a second core concentric to the first central core. The first optical fiber has a first end. Light exiting the first central core at the first end propagates along a first axis. Light exiting the second core at the first end propagates along the first axis. A multiplexing/demultiplexing optical coupling unit (mux/demux) is proximate the first end of the first fiber. The mux/demux comprises a first diffractive optical element and a second diffractive optical element arranged so that the light propagating from the first central core is incident on the first diffractive optical element and then incident on the second diffractive optical element and, after passing through the mux/demux, propagates along a second axis. Light from the second core, after passing through the mux/demux, propagates along a third axis that is displaced relative to the second axis.

Another embodiment of the invention is directed to an optical device that has a first fiber having a first end and at least a first core and a second core. The at least a first core and a second core are concentric. A second fiber has a second end and at least a first core. A third fiber has a third end and at least a first core. The device also includes an optical add/drop unit comprising at least one diffractive optical element. The optical add/drop unit is disposed to receive light from the first end of the first fiber and to direct light from one of the first core and the second core of the first fiber into the first core of the second fiber and light from the other of the first core and second core of the first fiber into the first core of the third fiber.

Another embodiment of the invention is an optical device that includes a first fiber having at least an inner concentric core and an outer concentric core. The inner concentric core of the first fiber is closer to an axis of the first fiber than the outer concentric core. The first fiber has a first end. The optical device also includes a second fiber having at least an inner concentric core and an outer concentric core. The inner concentric core is the second fiber is closer to an axis of the second fiber than the outer concentric core of the second fiber. The second fiber has a second end. The optical device also includes an optical coupling unit disposed between the first end of the first fiber and the second end of the second fiber. The optical coupling unit includes at least two diffractive optical elements. Light from the inner concentric core of the first fiber is directed by the optical coupling unit to the outer concentric core of the second fiber, and light from the outer concentric core of the first fiber is directed by the optical coupling unit to the inner concentric core of the second fiber.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A schematically illustrates an embodiment of an optical communications system that uses space division multiplexing to propagate optical communications signals along a single optical fiber in different concentric fiber modes, according to the present invention;

FIG. 1B schematically illustrates another embodiment of an optical communications system that uses space division multiplexing to propagate optical communications signals along a single optical fiber in different concentric fiber modes according to the present invention;

FIGS. 2A and 2B schematically illustrate an exemplary circularly symmetric, radial refractive index profile of a concentric multicore fiber (MCF), as used in an embodiment of the present invention;

FIG. 3A schematically illustrates near-field light propagation out of the end of a concentric MCF;

FIG. 3B schematically illustrates far-field light propagation out of the end of a concentric MCF;

FIGS. 4A-4E schematically illustrate an embodiment of an SDM coupler for coupling light between cores of a concentric MCF fiber and respective single core fibers, according to the present invention;

FIG. 5A schematically illustrates a side view of the fiber axes of the embodiment of SDM coupler illustrated in FIGS. 4A-4E, according to the present invention;

FIG. 5B schematically illustrates a side view of the fiber axes in another embodiment of SDM coupler, according to the present invention;

FIG. 6A schematically illustrates an end view of the fiber axes of the embodiment of SDM coupler illustrated in FIGS. 4A-E, according to the present invention;

FIG. 6B schematically illustrates an end view of the fiber axes of the embodiment of SDM coupler illustrated in FIG. 7, according to the present invention;

FIG. 7 schematically illustrates another embodiment of an SDM coupler for coupling light between cores of a concentric MCF fiber and respective single core fibers, according to the present invention;

FIG. 8A schematically illustrates another embodiment of an SDM coupler for coupling light between cores of a concentric MCF fiber and a conventional MCF, according to the present invention;

FIG. 8B schematically illustrates a cross-section through a conventional MCF;

FIGS. 9A-9C schematically illustrate an embodiment of an SDM add/drop filter for coupling light between at least one core of a concentric MCF and another fiber, according to the present invention;

FIGS. 10A-10C schematically illustrate another embodiment of an SDM add/drop filter for coupling light between at least one core of a concentric MCF and another fiber, according to the present invention;

FIGS. 11A-11C schematically illustrate another embodiment of an SDM add/drop filter for coupling light between at least one core of a concentric MCF and another fiber, according to the present invention; and

FIGS. 12A and 12 B schematically illustrate an embodiment of an SDM coupler for coupling optical signals between different cores of two concentric MCFs, according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

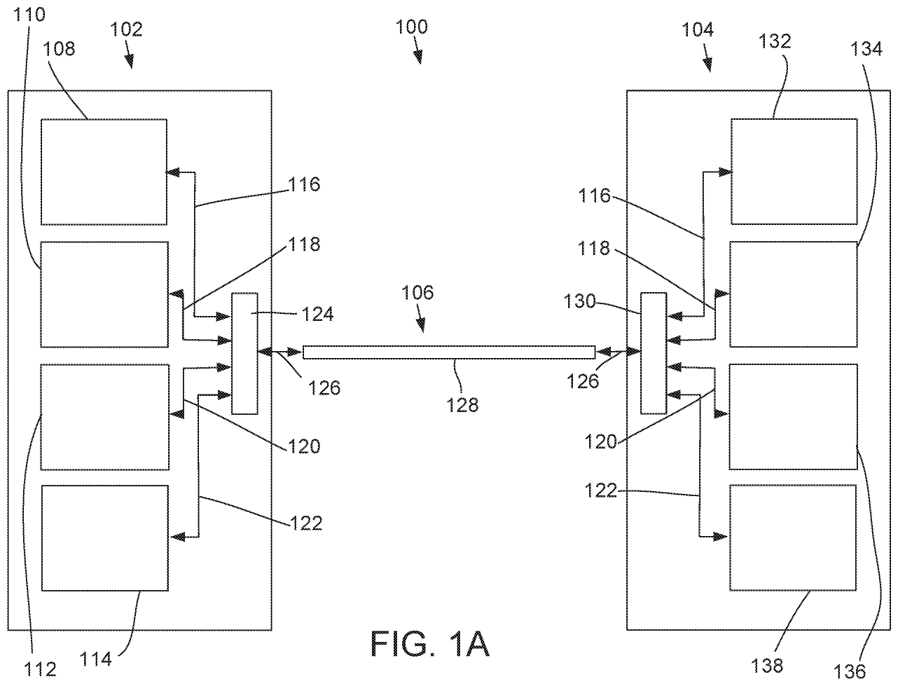

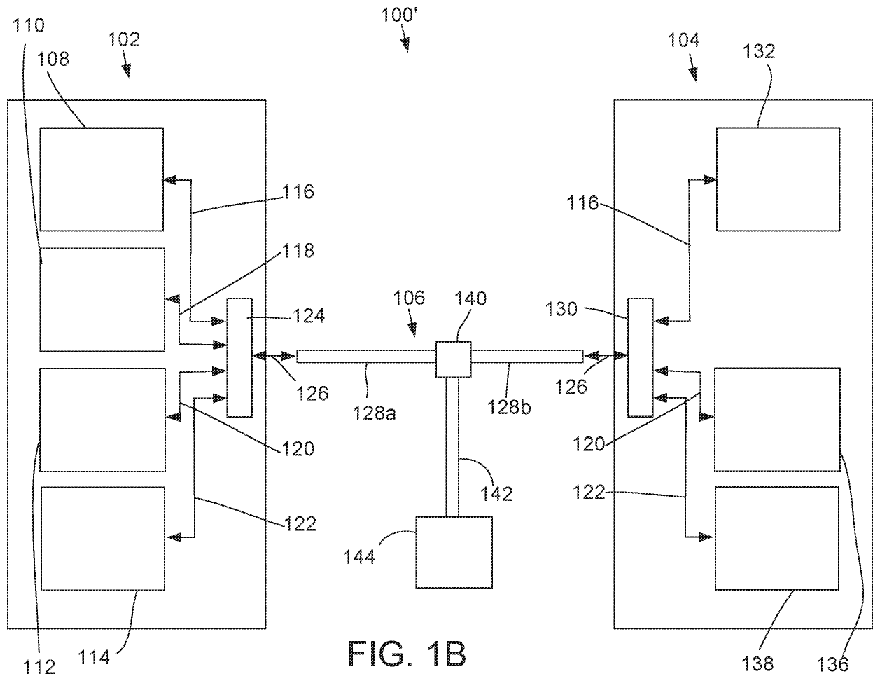

An exemplary embodiment of an optical communication system 100 is schematically illustrated in FIG. 1. The optical communication system 100 generally has a transmitter portion 102, a receiver portion 104, and a fiber optic portion 106. The fiber optic portion 106 is coupled between the transmitter portion 102 and the receiver portion 104 for transmitting an optical signal from the transmitter portion 102 to the receiver portion 104.

In this embodiment, the optical communication system 100 is of a space division multiplexing (SDM) design. Optical signals are generated within the transmitter portion 102 and are combined into different modes of a concentric multicore fiber (MCF) 128 in the optical fiber portion 106 and transmitted to the receiver portion 104, where the signals that propagated along different fiber modes are spatially separated and directed to respective detectors. The illustrated embodiment shows an optical communication system 100 that spatially multiplexes four different signals, although it will be appreciated that optical communications systems may spatially multiplex different number of signals, e.g. two, three or more than four.

Transmitter portion 102 has multiple transmitter units 108, 110, 112, 114 producing respective optical signals 116, 118, 120, 122. The optical communication system 100 may operate at any useful wavelength, for example in the range 800-950 nm, or over other wavelength ranges, such as 1250 nm-1350 nm, 1500 nm-1600 nm, or 1600 nm-1650 nm. Each transmitter unit 108, 110, 112, 114 is coupled to the optical fiber system 106 via a space division multiplexed (SDM) multiplexer/demultiplexer (“mux/demux”) 124, that directs the optical signals 116, 118, 120, 122 into respective modes of the concentric MCF 128 of the optical fiber system 106. Embodiments of the concentric MCF 128 and the SDM mux/demux 124 are discussed below. A multiplexer/demultiplexer is an optical device that, for light traveling in one direction, combines signals from two or more fibers into a single fiber and, for light propagating in the opposite direction, splits light from a single fiber into two or more fibers.

The multi-spatial mode optical signal 126 propagates along the optical fiber system 106 to the receiver portion 104, where it is split by a second SDM mux/demux 130 into the optical signals 116, 118, 120, 122 corresponding to the different spatial modes of the concentric MCF 128 that were excited by light from the SDM coupler 124. Thus, according to this embodiment, the transmitter unit 108 produces an optical signal 116, which is transmitted via a first spatial mode of the concentric MCF 128 to the receiver unit 132, the transmitter unit 110 produces an optical signal 118 which is transmitted via a spatial second mode of the concentric MCF 128 to the receiver unit 134, the transmitter unit 112 produces an optical signal 120, which is transmitted via a third spatial mode of the concentric MCF 128 to the receiver unit 136, and the transmitter unit 114 produces an optical signal 122 which is transmitted via a fourth spatial mode of the concentric MCF 128 to the receiver unit 138, with all of the optical signals 116, 118, 120, 122 propagating along the same concentric MCF 128. In this manner, the optical signal 116 may be detected at receiver unit 132 substantially free of optical signals 118, 120 and 122, the optical signal 118 may be detected at receiver unit 134 substantially free of optical signals 116, 120 and 122, the optical signal 120 may be detected at receiver unit 136 substantially free of optical signals 116, 118 and 122, and the optical signal 122 may be detected at receiver unit 138 substantially free of optical signals 116, 118 and 120.

Furthermore, in many optical communications systems there are optical signals propagating in both directions along an optical fiber. This possibility is indicated in FIG. 1, where the optical signals are designated with double-headed arrows. In such a case, the transmitter units and receiver units may be replaced by transceiver units that generate and receive signals that propagate along a particular mode of the concentric MCF 128. In other embodiments, there may be a separate transmitter unit and receiver unit for a signal at each end of the optical fiber system 106.

In addition, a signal from a transmitter need not be restricted to only one wavelength. For example, one or more of the transmitter units 108, 110, 112 and 114 may produce respective wavelength division multiplexed signals 116, 118, 120, 122 that propagate along respective modes of the concentric MCF 128. In such a case, the receiver units 132, 134, 136 and 138 may each be equipped with wavelength division demultiplexing units so that the optical signal at one specific wavelength can be detected independently from the optical signals at other wavelengths.

Another embodiment of optical communication system 100′ is schematically illustrated in FIG. 1B. This system 100′ is similar to that shown in FIG. 1A, except the optical fiber system 106 comprises at least two lengths of concentric MCF 128a, 128b which are connected via an add/drop filter 140. The add/drop filter 140 directs light from at least one of the cores of the optical fiber system 106 to a transceiver unit 144 via a fiber link 142. If the add/drop filter 140 directs an optical signal from just one core of the optical fiber system 106, then the fiber link 142 may be a single core fiber, for example a single mode fiber. In the illustrated embodiment, the signal 118 from the second transmitter unit 110 is directed by the add/drop filter 140 to the transceiver 144, with the result that the receiver portion 104 does not receive signal 118. Thus, the add/drop filter 140 ‘drops’ one of the channels passing between the transmitter portion 102 and the receiver portion 104 to the transmitter unit 140.

For optical signals traveling in the opposite direction, the transceiver 144 may direct signals to the second transmitter unit 110 in the transmitter portion 102, in which case the transmitter units 108, 110, 112, 114 may be transceiver units. Thus, the add/drop filter 140 adds a channel to those propagating from the receiver portion 104 to the transmitter portion 102.

A concentric MCF is an optical fiber that contains two or more concentric volumes of material having a higher refractive index than the immediately surrounding material, designed for different light signals to propagate in a confined manner along each respective concentric volume. For example, the concentric MCF may contain an axial core of relatively high refractive index, surrounded by cylinders of relatively high refractive material, where the volumes of relatively high refractive index material are separated from each other by volumes of relatively low index material. The relatively high and low refractive index material may be, for example, doped or undoped regions of silica glass.

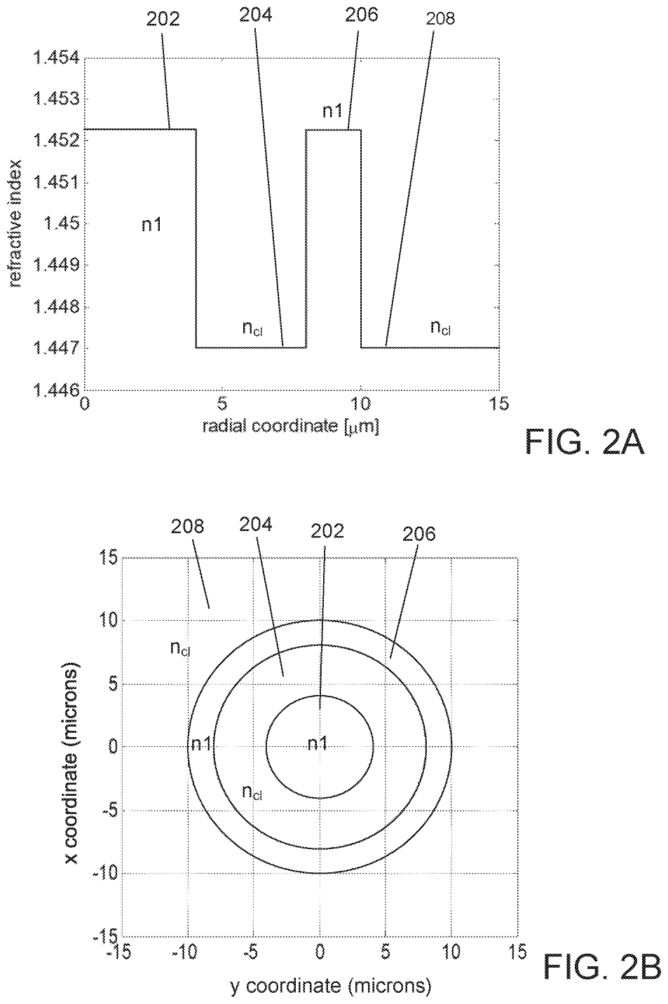

The refractive index profile of one embodiment of a concentric MCF fiber is described with reference to FIGS. 2A and 2B. FIG. 2A shows the refractive index profile as a function of radial position from the center of the fiber, while FIG. 2B shows the refractive index contours of a cross-sectional profile of the fiber. In this embodiment, there is a central core 202 of material having a relatively high refractive index, n1. The central core 202 is surrounded by a first ring of low index material 204, having a relatively low refractive index, n_{cl}. The first ring of low index material 204 is surrounded by a first ring of relatively high index material 206 having a relatively high refractive index, n1. The first ring of relatively high index material 206 is surrounded by material having a relatively low index 208, with a refractive index of n_{cl}. The central core 202 and the first ring of relatively high refractive index material (and any other rings of relatively high index material surrounding the central core and the first ring 206) are referred to as concentric cores.

A concentric MCF can be made using known processes for providing a desired refractive index profile in an optical fiber, such as a silica optical fiber, including chemical vapor deposition techniques such modified chemical vapor deposition (MCVD) or plasma enhanced chemical vapor deposition (PCVD), or processes described in U.S. Pat. No. 6,062,046.

In the particular embodiment of concentric MCF shown in FIGS. 2A and 2B, the core region 202 has a refractive index of 1.452 and a radius of 4 μm, the first low index cladding region 204 has an index of 1.447 and is present in the radial region 4 μm to 8 μm from the fiber center. The high index cylindrical core 206 has a refractive index the same as the core region 202 and is located between 8 μm and 10 μm from the fiber center. The outer low index cladding region 208 has the same refractive index as the first cladding region 204 and is located at a radial distance of more than 10 μm from the fiber center. Thus, the refractive index difference between the high and low index regions of this embodiment of fiber is 0.005. However, other values of refractive index may be used in the different core regions and cladding regions, the central core region may extend to a different radius, and the cylindrically concentric core 206 may extend radially between different values of radius.

Other embodiments of concentric MCFs may be employed. For example, there may be more than one concentric cylindrical core surrounding the central core, with different concentric cores positioned at increasing radial distances from the central core. In other embodiments, the values of refractive index in each of the concentric cores need not all be the same. For example, the central core may have a first refractive index and other concentric cores may have refractive indices that are more or less than that of the central core. In other embodiments, the refractive indices of the concentric cores may be highest for the central core and decreasing for concentric cores with increasing radial distance from the central core. In other embodiments still, the refractive index of the cladding material between concentric cores need not be radially uniform. For example, the refractive index of the cladding between the central core and the first cylindrically concentric core may be different from the refractive index between the first cylindrically concentric core and a second cylindrically concentric core. Concentric MCFs are further described in U.S. patent application Ser. No. 15/996,018, filed on Jun. 1, 2018, and the disclosure of which is incorporated herein by reference. The invention is not restricted to the embodiments of concentric MCF specifically described with respect to the figures in U.S. patent application Ser. No. 15/996,018, either to the values of refractive index for the various portions of the fiber, and the concomitant refractive index differences between adjacent fiber regions, nor to the specific radii of the various core and cladding.

Furthermore, it is understood that the change in refractive index between one region of the fiber and another need not be a step index change, but may take place over a non-zero range of radius. Furthermore, in the example discussed above with reference to FIGS. 2A and 2B, the concentric cores are intended to carry a single radial mode. However, the current invention is not limited to concentric MCFs that have cores capable of carrying only a single radial mode, but is also intended to cover concentric MCFs that have multimode concentric cores.

A consideration in implementing a concentric MCF fiber in an optical system is the ability to couple different light signals into and out of the concentric MCF. It is desirable that a concentric MCF optic system includes at least the following two functions. The first function is that of a multiplexer/demultiplexer (mux/demux), in which light from two or more single core fibers (“SCFs”) are launched into different cores of a concentric MCF (mux), or the reverse, in which the outputs from different cores of a concentric MCF are directed to the cores of respective SCFs (demux). The second function is that of an add/drop multiplexer, in which light from an SCF is injected into one of the cores of the concentric MCF (add) or light is extracted from one of the cores of the concentric MCF to an SCF (drop) while allowing light in the other cores of the concentric MCF continue propagating. These two functions are standard building blocks for spatially multiplexing and demultiplexing signals from multiple single core fibers, including single mode fibers. Other variations may be useful, however, such as adding or dropping more than one, but not all, of the spatially-multiplexed channels.

In many situations the only difference between a multiplexer and demultiplexer, or between an add filter and a drop filter, is the direction of the light, e.g. from one fiber to many, or from many fibers to one. It will be understood that the propagation of light in many of the optical systems described herein is reversible, i.e. light can travel from a first end of the system to the second end, or from the second end to the first end. For clarity, much of the following description, and the claims, discusses the propagation of light in only one direction. This is not intended to be a limitation on the invention, and it is intended that the description and claims cover optical systems in which light travels in both forwards and reverse directions.

Since one purpose of a concentric MCF fiber is to increase the transmission capacity of fiber, it is often desirable that an optical the optical system that uses a concentric MCF be compatible with wavelength multiplexing and other methods for increasing the transmission capacity of an optical fiber link.

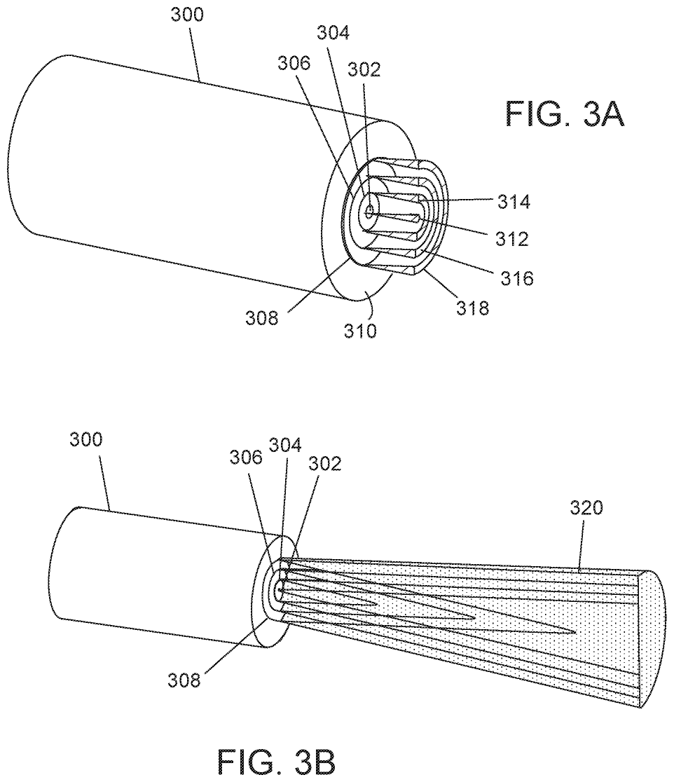

When considering the requirements of a mux/demux, or of an add/drop filter, is it important first to understand how light couples into and out of the concentric MCF. FIGS. 3A and 3B schematically illustrate the free space propagation of light that has passed out of the end of a concentric MCF fiber 300 and, therefore, how light can be transmitted into the concentric MCF 300. These illustrations show cross-sections through the beams of light emitted by the concentric cores. In this exemplary embodiment, the SDM fiber 300 is assumed to have a central axial core 302, surrounded by three concentric cylindrical cores, 304, 306 and 308, for a total of four concentric cores. FIG. 3A schematically illustrates the propagation of light over a distance relatively close to the fiber end 310. The light beam 312 exiting the fiber core 302 is divergent, as are the light beams 314, 316, 318 exiting from respective concentric cores 304, 306, 308. Relatively close to the fiber end 310 the divergent light from each core does not overlap with light from other cores. For the purposes of this disclosure, this distance may be regarded as being ‘near-field.’ As is shown in FIG. 3B, however, further away from the fiber end 310 the light beams 312-318 have completely overlapped, to form an overlapped beam 320, which can add to the complexity of coupling separate light signals into and out of respective concentric cores of the fiber 300. The region where the light beams overlap may be regarded as being ‘far-field.’

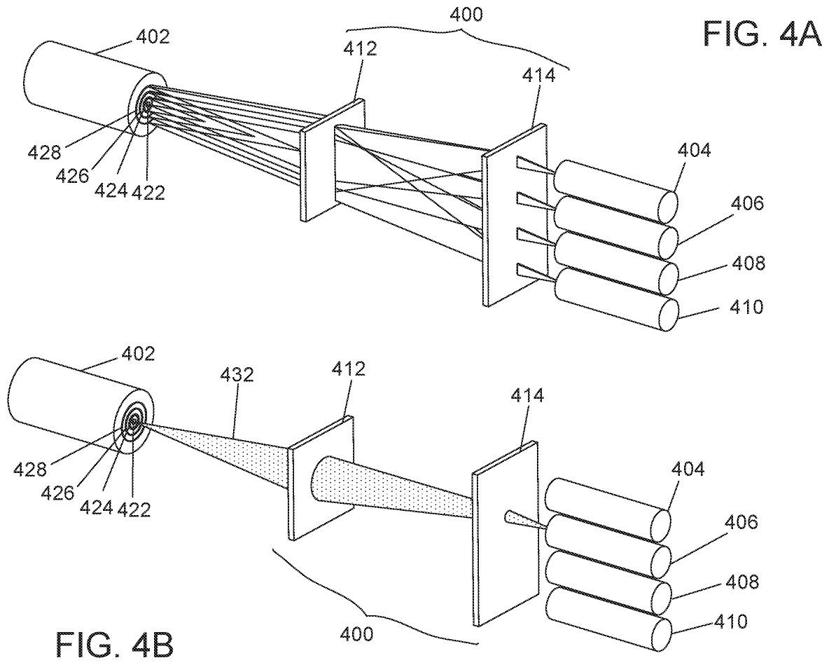

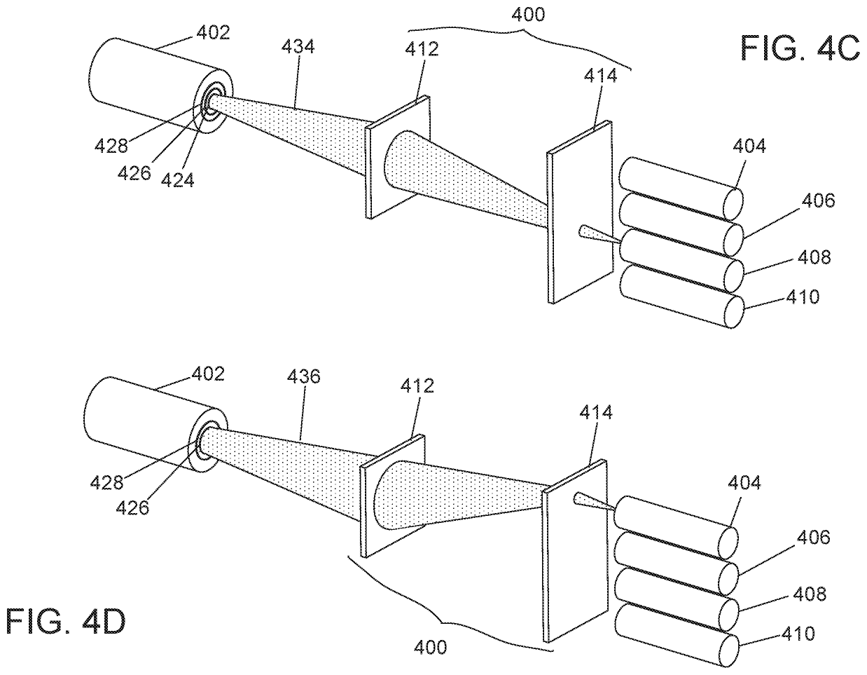

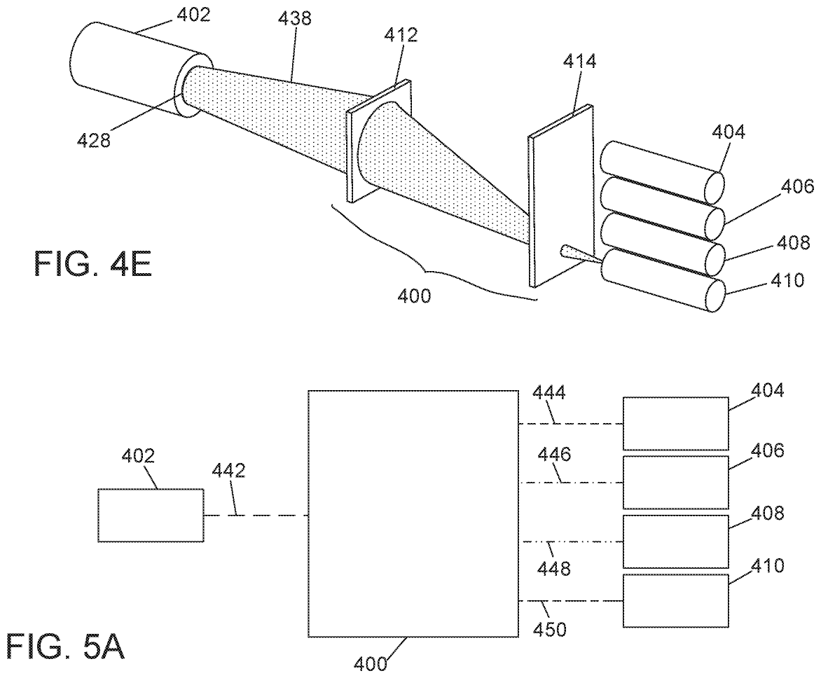

Some of the optical systems here are useful for coupling light between a concentric MCF and multiple SCFs. One approach for coupling light between cores of a concentric MCF 402 and a number of respective SCFs 404, 406, 408, 410, in other words multiplexing/demultiplexing, is now described with reference to FIGS. 4A-4E. As shown in FIG. 4A, a multiplexing/demultiplexing SDM coupler 400 includes a first diffractive optical element (“DOE”) 412 and a second DOE 414, positioned between the concentric SDM fiber 402 and single core fibers 404, 406, 408, 410. In this particular embodiment, the concentric SDM fiber 410 has four concentric cores labeled respectively from the axis of the fiber 410 radially outward from the center core as 422, 424, 426 and 428.

Diffractive optical elements are fabricated such that transmission through, or reflection from, a diffractive optical element changes the phase of the optical signal at the surface of the DOE. DOEs are typically planar devices and are most often used in transmission. However non-planar DOEs and reflective DOEs may also be used for the same purpose as described herein, with some modification that would be understood by one of ordinary skill. DOEs may also be referred as “digital optical elements” or “holographic optical elements” (HOEs). DOEs may be manufactured by etching a transparent substrate using a series of precise masks, with the resulting surface being an elaborate array of three-dimensional steps that provide the DOE with its optical properties. The fabrication of DOEs takes advantage of the ultra-high precision lithographic techniques that are common in the semiconductor industry. The “digital” nature of many DOEs allows the surface to be patterned in limitless ways, allowing DOEs to accomplish functions that are frequently difficult to achieve with conventional refractive optical elements. Using wafer-scale processing, DOEs can be made in high volumes at low cost. It is also possible to create a “master” DOE using an etching technique, and then to replicate this DOE on polymer substrates using standard microreplication techniques.

It is the flexibility of the patterning of a DOE that allows DOEs to be used in the optical devices for use with concentric MCFs as set forth in this disclosure. Some DOEs are formed with parts having multiple discrete levels or thicknesses, which can be referred to as “digital”, other DOEs are made with levels or thicknesses that vary continuously, in which case the DOE can be referred to as “analog” or “grayscale”. By nature, diffraction depends on wavelength. However, DOEs can be designed to operate efficiently over a wide range of wavelengths. Such achromatic behavior may be advantageous in the present invention, where the wavelength of the light used in the concentric SDM optical system may vary over a range of e.g. 1250 nm-1650 nm.

In this embodiment, the central core 422 of the concentric MCF 402 sustains the propagation of light in a single radial mode. Thus, when the light propagates out of the central core 422, it diffracts in a conical pattern. The intensity distribution of the light from the central core 422 has a spatial distribution that is approximately a Gaussian function of radius. Light emitted from the other cores 424, 426, 428 has the distribution of axially-symmetric “rings” which merge into a cone of light in the far field. FIG. 4A shows a “cut-away” view of the light beams propagating between the fibers 402 and 404, 406, 408, 410.

The light from the different concentric cores 422, 424, 426, 428 of the concentric SDM fiber 402 is directed into respective single core fibers (SCFs) 406, 408, 404, 410 via the SDM coupler 400. The single core fibers 404, 406, 408, 410 may be single mode fibers (SMFs). To increase the efficiency of coupling between the concentric SDM fiber and the SCFs, it is preferred that the intensity and phase of light incident on a core match the intensity and phase of light that would be emitted from that core if light were to be passing through the system in the reverse direction. This is true of both single- and multi-core single mode fibers. While a single DOE is able to change the phase of light at the surface of the DOE, resulting in an intensity change in the far field, it is preferred that at least two DOEs 412, 414 are used in the SDM coupler 400 to increase the efficiency of coupling between the concentric SDM fiber 402 and the SCFs. Additional DOEs may be used to further increase coupling efficiency between fibers.

FIG. 4B schematically illustrates the SDM coupler 400 in use with one beam of light 432 propagating out of the central core 422 of the concentric MCF 402. The light beam is 432 is directed to the SCF 406 by the SDM coupler 400. FIG. 4C schematically illustrates the SDM coupler 400 in use with one beam of light 434 propagating out of the first cylindrical concentric core 424 of the concentric MCF 402. The light beam is 434 is directed to the SCF 408 by the SDM coupler 400. FIG. 4D schematically illustrates the SDM coupler 400 in use with one beam of light 436 propagating out of the second cylindrical concentric core 426 of the concentric MCF 402. The light beam is 436 is directed to the SCF 404 by the SDM coupler 400. FIG. 4E schematically illustrates the SDM coupler 400 in use with one beam of light 438 propagating out of the third cylindrical concentric core 428 of the concentric MCF 402. The light beam is 438 is directed to the SCF 410 by the SDM coupler 400.

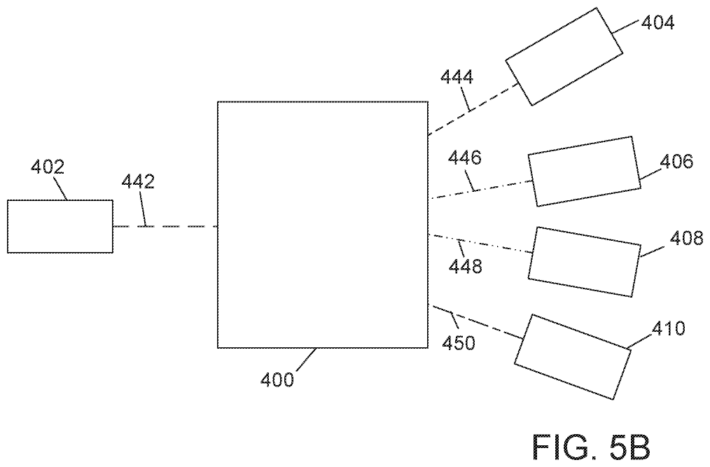

It is useful to consider the optical axes of the various light beams as they propagate from the concentric MCF 402 to their respective SCFs 404-410, with reference to FIG. 5A. Since the various cores of the concentric MCF 402 are concentric around the axis 442 of the fiber 402, the light propagating out of the concentric MCF 402 propagates along the axis 442, albeit in a divergent manner. In addition to changing the phase of the beams from the various concentric cores 422, 424, 426, 428 of the MCF fiber, the SDM coupler 400 also separates the beams so that, at the output side, the beams propagate along their respective axes, i.e. beam 432 from concentric core 422 propagates along axis 446 to SCF 406. Likewise, beam 434 from core 424 is directed by the SDM coupler along axis 448 to the SCF 408, beam 436 from core 426 is directed by the SDM coupler along axis 444 to the SCF 404, and beam 438 from core 428 is directed by the SDM coupler along axis 450 to the SCF 410. Thus, upon entering the SDM coupler 400 from the concentric MCF 402, the light all propagates along the axis 442. However, upon exiting the SDM coupler 400, light from one concentric core of the concentric MCF propagates along an axis that is laterally displaced relative to the axis along which light from one of the other concentric cores propagates.

In another embodiment, schematically illustrated in FIG. 5B, upon exiting the SDM coupler 400, the light from each core propagates along a different direction from the light from the other cores, in other words the axes 444, 446, 448, 450 are not parallel to one another. In this embodiment, upon exiting the SDM coupler 400, light from one concentric core of the concentric MCF propagates along an axis that is angularly displaced relative to the axis along which light from one of the other concentric cores propagates. To achieve this angular separation, rather than the lateral separation shown in FIG. 5A, at least one of the DOEs used in the SDM coupler 400 is different from those used in the embodiment of FIG. 5A.

In a variation of this embodiment, rather than the SDM coupler 400 having just a single second DOE 414, it may have a number of second DOEs, each one aligned to a respective SCF 404, 406, 408, 410. Furthermore, in certain embodiments, rather than the SDM coupler 400 having a second DOE 414, the SDM coupler 400 may have an array of individual focusing elements, such as lenses, to direct the respective beams from the first DOE 412 to their respective SCFs 404, 406, 408, 410.

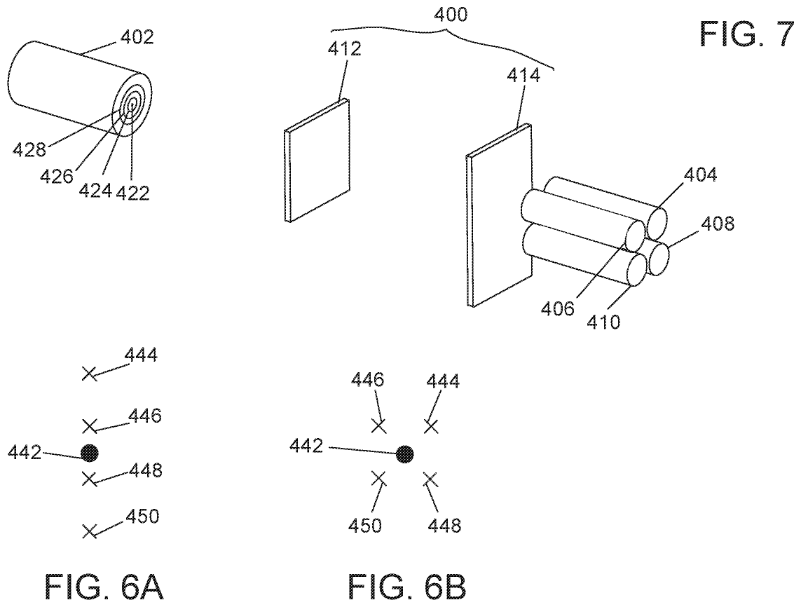

Another way of viewing the optical axes described in FIG. 5A is to consider them end-on, rather than side-on. This is shown in FIG. 6A for this embodiment, as if looking along the axes parallel to the plane of the figure in FIG. 5. The axis of the concentric MCF 402 is shown as the filled circle 442, while the axes of the SCFs 404, 406, 408, 410 are shown as crosses 444, 446, 448 and 450. In this embodiment, the SCFs 404, 406, 408, 410 are arranged linearly, so their axes form a line in FIG. 6A. Another way of saying this is that the axes 444, 446, 448, 450 lie in the same plane.

The SCF's need not be arranged linearly, and can be arranged in any suitable pattern. For example, in another embodiment, schematically illustrated in FIG. 7, the SCFs 404, 406, 408, 410 are arranged in a square pattern. In one arrangement, the square pattern is centered on the axis 442 of the concentric MCF. This situation is schematically illustrated in FIG. 6B for the axes 444, 446, 448, 450 of the SCFs 404, 406, 408, 410. Like FIG. 6A, the axis of the concentric MCF 402 is the filled circle 442, while the axes of the SCFs 404, 406, 408, 410 are the crosses 444, 446, 448, 450. In this arrangement, 444, 446, 448, 450 of the SCFs 404, 406, 408, 410 are substantially equidistant from the axis 442 of the concentric MCF 402.

Other arrangements of SCFs are possible. For example, the square arrangement shown in FIG. 7 need not be centered around the axis of the concentric MCF, but may be in an offset position, for example, with one of the SCF axes being colinear with the concentric MCF axis 442. In other examples, the axes of the SCFs may be set in a rectangular pattern, or in a diamond pattern. Other arrangements of SCFs may be possible with different numbers of SCFs. For example, if there are three SCFs, the SCFs may be arranged in a line or in a triangle. In one such embodiment, the three SCF axes may be arranged such that they form an equilateral triangle, the center of which is aligned with the axis of the concentric MCF: in such a situation, the axes of the MCFs would be said to be equidistant from the axis of the concentric MCF. Further spatial arrangements may be made with two, five, six or more SCFs.

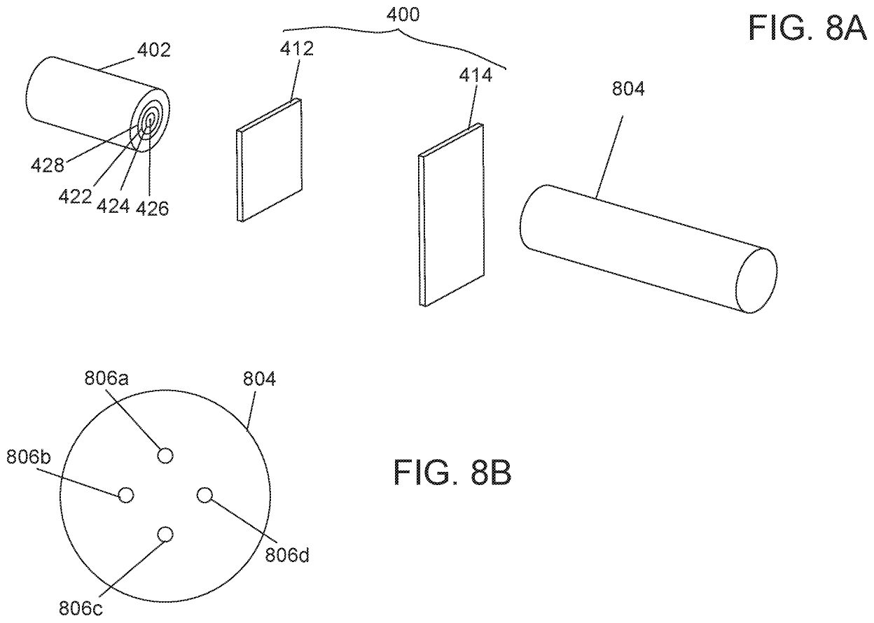

In another embodiment, the SDM coupler 400 may be used for coupling light from a concentric MCF 402 to another MCF 804 which may be a conventional arrayed-core MCF having an array of non-concentric, single-mode cores 806a-806d, as is schematically illustrated in FIGS. 8A and 8B. In the illustrated embodiment, the arrayed-core MCF has four single mode cores. In another embodiment, the MCF 804 may be formed by fusing together the ends of four separate SCFs arranged parallel to each other, to produce a patterns of cores 806a-806d as shown in FIG. 8B. Such SCFs may be tapered before being fused.

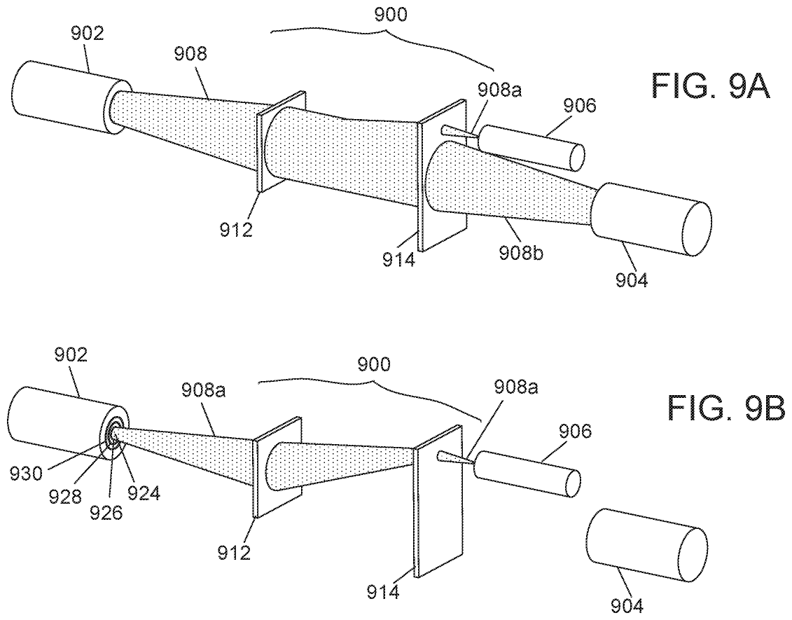

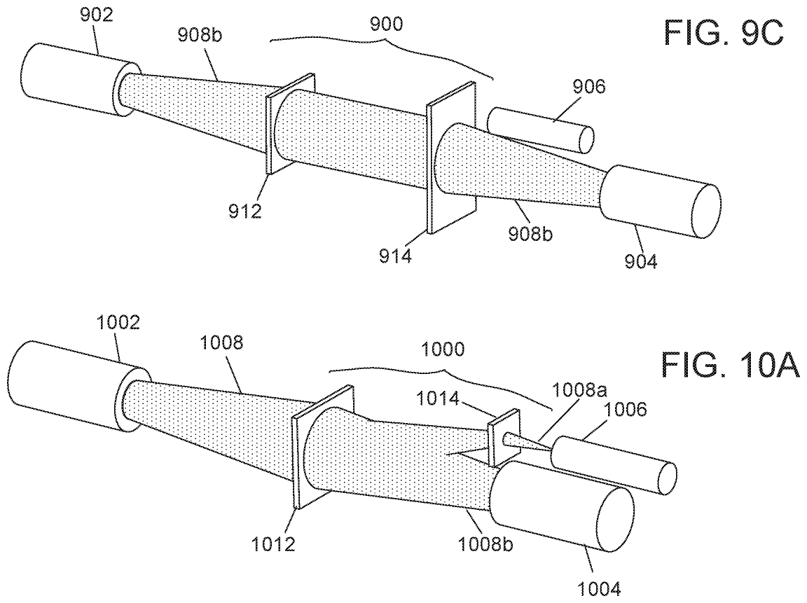

An add/drop filter for a concentric MCF may be formed using one, two or more DOEs. In the embodiment schematically illustrated in FIG. 9A, a concentric MCF 902 is coupled via an add/drop filter 900 to a second concentric MCF 904 and a SCF 906. Light 908 from the concentric MCF 902 is directed through the add/drop filter 900 to the second concentric MCF 904 and the SCF 906. In the illustrated embodiment, the add/drop filter 900 comprises two DOEs 912, 914, although it could include fewer or more DOEs. Light beam 908a is directed by the add/drop filter 900 to the SCF 906, while the remainder of the light beam 908b is directed to the second concentric MCF 904.

In this embodiment, the concentric MCF 902 has 4 concentric cores 924, 926, 928, 930, although it could have more or fewer concentric cores. FIG. 9B illustrates light 908a from the second core 926 (counting out from the center of the concentric MCF 902) being directed by the add-drop filter 900 to the SCF 906. FIG. 9C illustrates light 908b from the other cores 924, 928, 930 being directed by the add/drop filter 900 to the second concentric MCF 904.

In other embodiments, the light from a different concentric core 924, 928, 930 may be directed to the SCF 906 instead of the light from the second concentric core 926. In additional embodiments, the light from more than one core 924, 926, 928, 930 of the concentric MCF 902 may be directed out of the beam directed towards the second concentric MCF. In such a case, the SCF 906 may be replaced by another MCF, for example a third concentric MCF.

It should be appreciated that, although the entrance face to the SCF 906 lies at a distance closer to the second DOE 914 than the entrance face to the second concentric MCF 904, this is not a necessary condition. The two fiber end faces may lie in the same plane, or the entrance face to the SCF 906 may lie at a distance further from the second DOE 914 than the entrance face to the second concentric MCF 904.

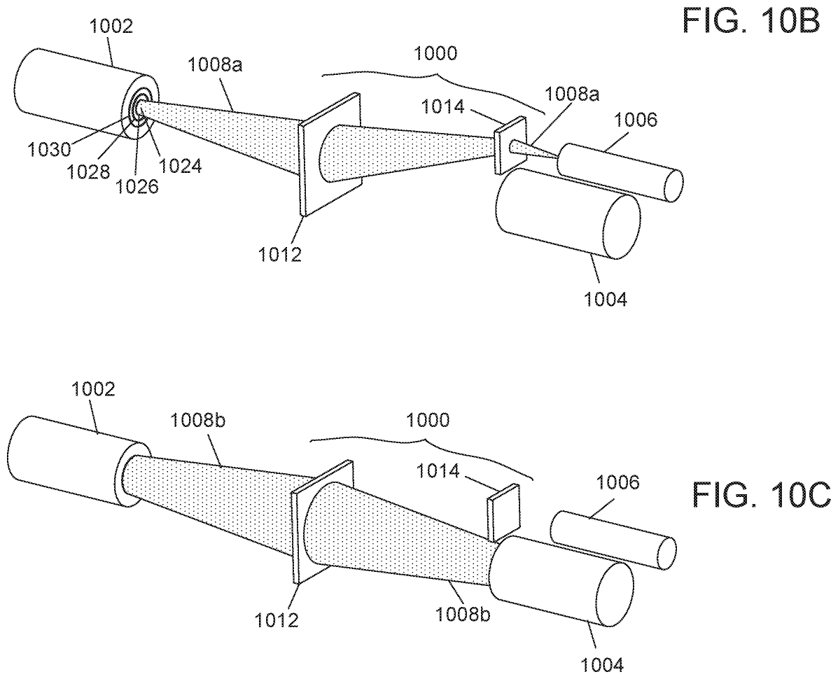

Another embodiment of add/drop filter 1000 is now described with reference to FIGS. 10A-10C. In the embodiment schematically illustrated in FIG. 10A, a concentric MCF 1002 is coupled via an add/drop filter 1000 to a second concentric MCF 1004 and an SCF 1006. Light 1008 from the concentric MCF 1002 is directed through the add/drop filter 1000 to the second concentric MCF 1004 and the SCF 1006. In the illustrated embodiment, the add/drop filter 1000 comprises at least one DOE 1012, although it could include more DOEs. The add/drop filter 1000 also includes a focusing element 1014 for focusing light 1008a from the DOE 1012 into the SCF 1006. The focusing element 1014 may be a lens, or some other type of focusing element, including a DOE. In this embodiment, the focusing element 1014 does not lie on the path of light from the first DOE 1012 to the second concentric MCF 1004. Light beam 1008a is directed to by the add/drop filter 1000 to the SCF 1006, while the remainder of the light 1008b is directed to the second concentric MCF 1004.

In this embodiment, the concentric MCF 1002 has 4 concentric cores 1024, 1026, 1028, 1030, although it could have more or fewer concentric cores. FIG. 10B illustrates light 1008a from the second core 1026 (counting out from the center of the concentric MCF 1002) being directed by the add-drop filter 1000 to the SCF 1006. FIG. 10C illustrates light 1008b from the other cores 1024, 1028. 1030 being directed by the add/drop filter 1000 to the second concentric MCF 1004. In this embodiment, the first DOE essentially images the light output from the cores 1024, 1028, 1030 to the cores of the second concentric MCF, while diverting the light output from the second core 1026 to the focusing element 1014.

In other embodiments, the light from a different concentric core 1024, 1028, 1030 may be directed to the SCF 1006 instead of the light from the second concentric core 1026. In other embodiments, the light from more than one core 924, 926, 928, 930 of the concentric MCF 902 may be directed out of the beam directed towards the second concentric MCF. In such a case, the SCF 906 may be replaced by another MCF, for example a third concentric MCF.

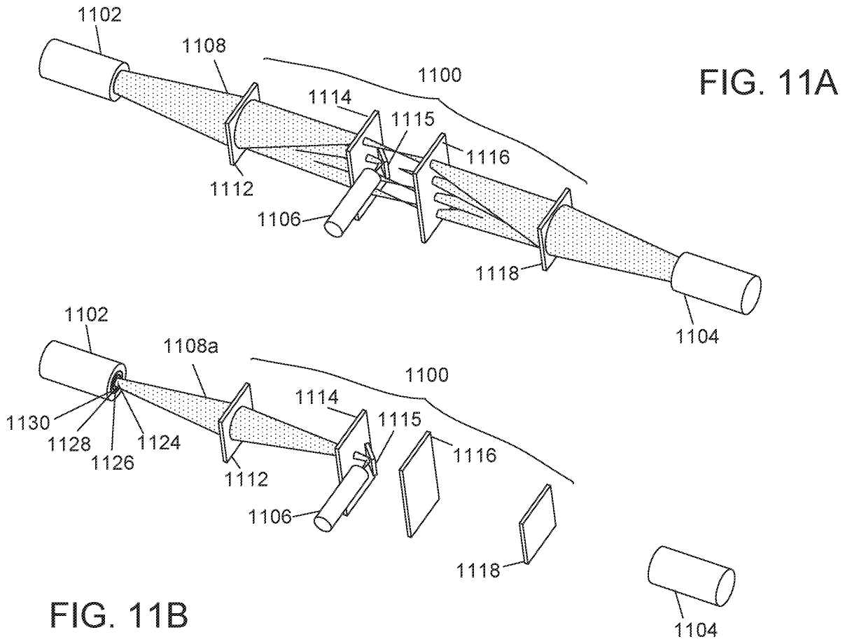

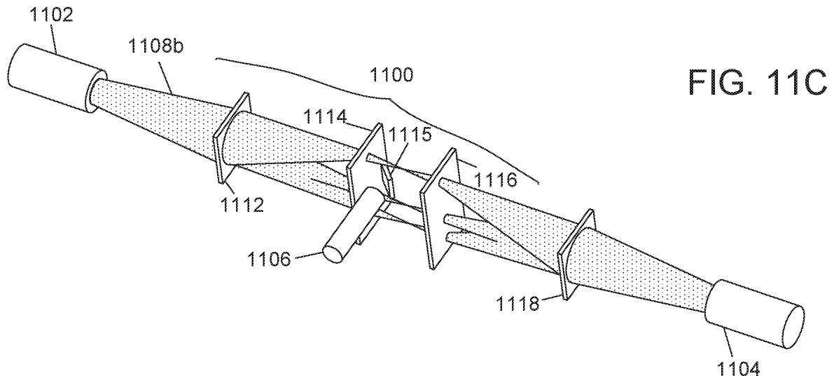

Another embodiment of add/drop filter is now described with reference to FIGS. 11A-11C. In this embodiment, schematically illustrated in FIG. 10A, a concentric MCF 1102 is coupled via an add/drop filter 1100 to a second concentric MCF 1104 and an SCF 1106. Light 1108 from the concentric MCF 1102 is directed through the add/drop filter 1100 to the second concentric MCF 1104 and the SCF 1106. In the illustrated embodiment, the add/drop filter 1100 comprises at least four DOEs 1112, 1114, 1106, 1118 although it could include more DOEs. The add/drop filter 1100 also includes a redirecting element 1115 for directing light out of the path to the second concentric MCF 1104 to the SCF 1106. The redirecting element 1115 may be, for example, a mirror, a prism operating in total internal reflection (TIR), or some other type of element that can redirect a light beam in a selected direction, for example a DOE. In this embodiment, the first and second DOEs 1112, 1114 separate and focus the beams from each of the concentric cores 1122, 1124, 1126, 1128 of the concentric MCF 1102, in a manner similar to that of DOEs 412, 414 in the SDM coupler 400. In fact, this add/drop filter 1100 may be thought of as two such SDM couplers back-to-back. An advantage of this type of add/drop filter, therefore, is that it can use the same DOEs as are used in an SDM coupler.

In this embodiment, the concentric MCF 1102 has 4 concentric cores 1124, 1126, 1128, 1130, although it could have more or fewer concentric cores. FIG. 11B illustrates light 1108a from the second core 1126 (counting out from the center of the concentric MCF 1102) being directed to the SCF 1106 by the redirecting element 1115. FIG. 11C illustrates light 1108b from the other cores 1124, 1128, 1130 being directed by the add/drop filter 1100 to respective cores in the second concentric MCF 1104.

In other embodiments, the light from a different concentric core 1124, 1128, 1130 may be directed to the SCF 1106 instead of the light from the second concentric core 1126. In other embodiments, the light from more than one core 1124, 1126, 1128, 1130 of the concentric MCF 1102 may be directed out of the beam directed towards the second concentric MCF. In such a case, the SCF 1106 may be supplemented by another SCF.

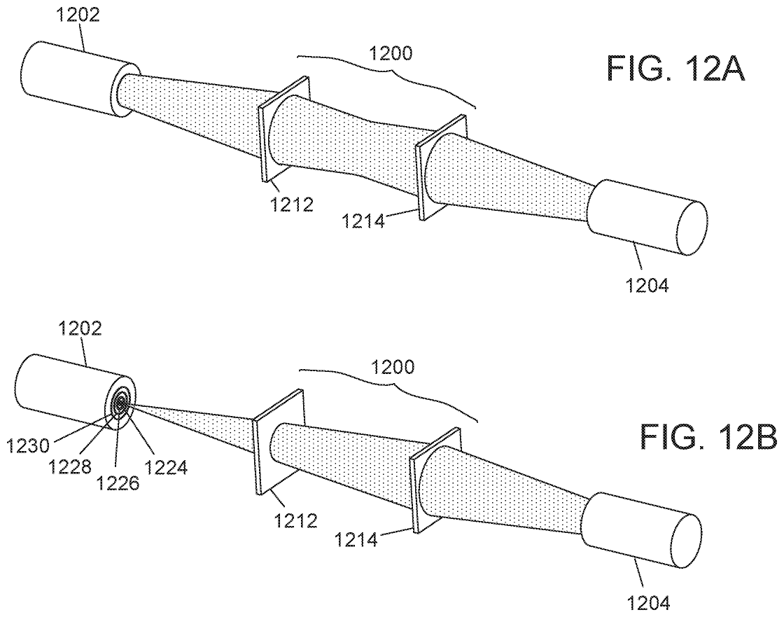

Another embodiment of an SDM coupler 1200 for concentric MCFs is schematically illustrated in FIGS. 12A and 12B. In this embodiment, the SDM coupler 1200 couples between a first concentric MCF 1202 and a second concentric MCF 1204. The first concentric MCF 1202 has four concentric cores 1224, 1226, 1228 and 1230, progressing from the center towards the edge of the fiber. These concentric cores may be labeled, in turn, as concentric cores 1, 2, 3 and 4. The second concentric MCF 1204 also has four concentric cores (not shown), which may also be labeled as concentric cores 1, 2, 3 and 4.

In this particular embodiment, the coupler 1220 directs light from cores of the first MCF 1202 to different cores of the second MCF 1204. In other words, rather than simply mapping light from core 1 of the first concentric MCF 1202 to core 1 of the second concentric MCF 1204, it maps from core 1 of the first concentric MCF 1202 to a different core of the second concentric MCF 1204, for example core 4. Thus, in one particular example, the SDM coupler 1200 may direct light between the pairs of cores shown in the following table:

| 1^{st} concentric MCF 1202 | 2^{nd} concentric MCF 1204 |
|---|---|
| 1 | 4 |
| 2 | 3 |
| 3 | 2 |
| 4 | 1 |

This type of SDM coupler may be useful, for example, to balance out the different speeds of light in the different concentric cores. For example, swapping the light from cores 1, 2, 3, and 4 in the first concentric MCF 1202 respectively to cores 4, 3, 2, and 1 of the second MCF 1204 midway along a path between a starting point and an end point, may reduce skew.

Of course, this is simply one example of mapping light signals between cores of different concentric MCFs, and other mappings may be used, such as from cores 1, 2, 3, 4 respectively to cores 2, 1, 4, 3; or from cores 1, 2, 3, 4, to cores 2, 3, 4, 1, and the like.

In a further embodiment, a concentric MCF path between a start point and an end point may include a number of such couplers that cycle each optical signal through each of the four cores, so that every optical signal is exposed to the same dispersion along the length of the concentric MCF transmission path between the start point and the end point. Thus, in one embodiment, the couplers may cycle the optical signals from cores 1, 2, 3, 4 respectively to cores 2, 3, 4, 1, and then to cores 3, 4, 1, 2, and then to 4, 1, 2, 3 before arriving at the transmission end point.

Various modifications, equivalent processes, as well as numerous structures to which the present invention may be applicable will be readily apparent to those of skill in the art to which the present invention is directed upon review of the present specification. For example, although many of the examples provided herein describe concentric MCFs having four concentric cores, the invention is intended to cover systems that use concentric MCFs having different numbers of concentric cores. In such cases, the number of corresponding SCFs may also change. Likewise, the couplers and filters have been described as using a certain number of DOEs. It may be, however, that the couplers and filters include different numbers of DOEs.

In the various embodiments of devices discussed herein, the DOEs have been shown separated from the optical fibers by an air gap and operating in the far field. This need not be the case, and the DOE may be attached directly to a fiber face. In such a case the alignment between a DOE and its respective fiber, or fibers, may be maintained through the use of an optically transparent adhesive. This approach reduces the number of air/dielectric interfaces and, thus, may reduce reflective losses in the device. Furthermore, the distance between the fiber end face and the patterned surface of the DOE may be controlled by careful selection of the thickness of the DOE substrate. Under this approach, the DOE may operate in the near-field of the concentric MCF.

Furthermore, the embodiments of the present invention described above have used a single concentric MCF as an input. However, this is not intended to be a limit of the invention, and there could be multiple concentric MCFs. For example, if a concentric MCF has M concentric cores, then an SDM coupler can couple to M SCFs. If there are N concentric fibers, then these can couple to N×M SCFs.

In other embodiments, the DOEs may be configured to transfer light between a conventional MCF, having single mode cores arranged in an array, instead of a concentric MCF, and multiple single mode fibers, either in a mux/demux configuration, add/drop configuration, or other configurations.

Finally, the description of the various DOE-based devices for use with concentric MCFs primarily described the optical signals propagating in a single direction, mainly from the concentric MCF on the left of the figure towards the various components on the right of the figure. It will be understood, of course, that optical signals may also be propagated in the opposite directions, and there is no intention in the present description to limit the direction in which optical signal propagate through the claimed optical devices.

As noted above, the present invention is applicable to fiber optical communication and data transmission systems. Accordingly, the present invention should not be considered limited to the particular examples described above, but rather should be understood to cover all aspects of the invention as fairly set out in the attached claims.

What we claim as the invention is:

1. An optical device, comprising:
a first optical fiber comprising a first central core and at least a second core concentric to the first central core, the first optical fiber having a first end, wherein light exiting the first central core at the first end propagates along a first axis and light exiting the second core at the first end propagates along the first axis; and
a multiplexing demultiplexing optical coupling unit (mux/demux) positioned proximate the first end of the first fiber, the mux/demux comprising a first diffractive optical element and a second diffractive optical element arranged so that the light propagating from the first central core is incident on the first diffractive optical element and then incident on the second diffractive optical element and, after passing through the optical coupling unit propagates along a second axis and the light from the second core, after passing through the optical coupling unit, propagates along a third axis that is displaced relative to the second axis.

2. An optical device as recited in claim 1, wherein the mux/demux focuses the light from the first central core at a first position along the second axis and the mux/demux focuses the light from the second concentric core at a second position along the third axis.

3. An optical device as recited in claim 2, further comprising a second fiber having an input end and a second fiber core, the input end of the second fiber core being located substantially at the first position of the second axis, and further comprising a third fiber having an input end and a third fiber core, the input end of the third fiber core being located substantially at the second position of the third axis.

4. An optical device as recited in claim 1, wherein the first optical fiber further comprises a third core concentric to the first central core and the second core, light exiting the third core at the first end propagates along the first axis, the light from the third core, after passing through the mux/demux, propagates along a fourth axis displaced relative to both the second axis and the third axis.

5. An optical device as recited in claim 4, wherein the second axis, the third axis and the fourth axis are positioned substantially equidistant from the first axis.

6. An optical device as recited in claim 4, wherein the second axis, the third axis and the fourth axis are substantially arranged in a plane.

7. An optical device as recited in claim 6, wherein the second axis, the third axis and the fourth axis are parallel to each other.

8. An optical device as recited in claim 1, wherein the second axis and the third axis are parallel to the first axis.

9. An optical device as recited in claim 1, wherein the second fiber is a single core fiber and the third fiber is a single core fiber.

10. An optical device as recited in claim 1, wherein the first optical fiber further comprises a third core concentric to the first central core and the second core, light exiting the third core at the first end propagates along the first axis and, after passing through the mux/demux, propagates along one of the second axis and the third axis.

11. An optical device as recited in claim 10, further comprising a second fiber having an input end and a single core, the input end of the single core of the second fiber being positioned on one of the second axis and the third axis so as to receive light from only one core of the first fiber, and further comprising a third fiber comprising a first central core and a second core concentric to the first central core of the third fiber, the third fiber having an input end positioned on the other of the second and third axis so as to receive light from more than one core of the first axis.

12. An optical device as recited in claim 1, wherein the third axis is laterally displaced relative to the second axis.

13. An optical device as recited in claim 1, wherein the third axis is angularly displaced relative to the second axis.

14. An optical device as recited in claim 1, further comprising an arrayed-core MCF having a first single mode core aligned with the second axis and a second single mode core aligned with the third axis.

15. An optical device, comprising:
a first fiber having a first end and at least a first core and a second core, the at least a first core and a second core being concentric;
a second fiber having a second end and at least a first core;
a third fiber having a third end and at least a first core;
an optical add/drop unit comprising at least one diffractive optical element, the optical add/drop unit being disposed to receive light from the first end of the first fiber and to direct light from one of the first core and the second core of the first fiber into the first core of the second fiber and light from the other of the first core and second core of the first fiber into the first core of the third fiber.

16. An optical device as recited in claim 15, wherein one of the first and second cores of the first fiber is a central core of the first fiber.

17. An optical device as recited in claim 15, wherein the first fiber further comprises a third core concentric with the first and second cores of the first fiber, the second fiber comprises a second core concentric with the first core of the second fiber, and wherein the optical add/drop unit directs light from the third core of the first fiber into the second core of the second fiber.

18. An optical device as recited in claim 17, the optical add/drop unit further comprising a focusing element on an optical path between the at least one diffractive optical element and the third fiber so as to focus light propagating from the at least one diffractive optical element to the third fiber.

19. An optical device as recited in claim 15, wherein the at least one diffractive optical element comprises first and second diffractive optical elements, light propagating between the first fiber and the second fiber passing through the first and second diffractive optical elements and light propagating between the first fiber and the third fiber passing through the first and second diffractive optical elements.

20. An optical device as recited in claim 15, wherein the at least one diffractive optical element comprises a first diffractive optical element and a focusing element, light propagating between the first fiber and the second fiber passing through the first diffractive optical element but not the focusing element, and light propagating between the first fiber and the third fiber passing through the first diffractive optical element and the focusing element.

21. An optical device as recited in claim 20, wherein the focusing element is one of a lens and a second diffractive optical element.

22. An optical device as recited in claim 15, wherein the at least one diffractive optical element comprises a first diffractive optical element, a second diffractive optical element, a third diffractive optical element, and a fourth diffractive optical element, light propagating between the first fiber and the second fiber passing through the first diffractive optical element, the second light propagating between the first fiber and the second fiber passing through the first diffractive optical element but not the focusing element, and light propagating between the first fiber and the third fiber passing through the first diffractive optical element and the focusing element, the third light propagating between the first fiber and the second fiber passing through the first diffractive optical element but not the focusing element, and light propagating between the first fiber and the third fiber passing through the first diffractive optical element and the focusing element and the fourth light propagating between the first fiber and the second fiber passing through the first diffractive optical element but not the focusing element, and light propagating between the first fiber and the third fiber passing through the first diffractive optical element and the focusing element, and light propagating between the first fiber and the third fiber passing through the first diffractive optical element and the second diffractive optical element, but not the third diffractive optical element or the fourth diffractive optical element.

23. An optical device as recited in claim 22, further comprising a beam redirecting element between the second diffractive optical element and the third diffractive optical element, to redirect light propagating between the first fiber and the third fiber.

24. An optical device, comprising:
a first fiber comprising at least an inner concentric core and an outer concentric core, the inner concentric core of the first fiber being closer to an axis of the first fiber than the outer concentric core of the first fiber, the first fiber having a first end;
a second fiber comprising at least an inner concentric core and an outer concentric core, the inner concentric core of the second fiber being closer to an axis of the second fiber than the outer concentric core of the second fiber, the second fiber having a second end; and
an optical coupling unit disposed between the first end of the first fiber and the second end of the second fiber, the optical coupling unit;
wherein light from the inner concentric core of the first fiber is directed by the optical coupling unit to the outer concentric core of the second fiber, and light from the outer concentric core of the first fiber is directed by the optical coupling unit to the inner concentric core of the second fiber.

25. An optical device as recited in claim 24, wherein the inner concentric core of the first fiber is a central core.

26. An optical device as recited in claim 25, wherein the inner concentric core of the second fiber is a central core.

27. An optical device as recited in claim 24, wherein the optical coupling unit comprises at least one diffractive optical element.

28. An optical device as recited in claim 24, wherein the optical coupling unit comprises at least two diffractive optical elements.
